(19) United States
(12) Patent Application Publication
(10) Pub. No.: US 2004/0255078 A1
(43) Pub. Date: Dec. 16, 2004

(54) Apparatus and method to control disc driving speed

(75) Inventor: Ki-ju Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/865,868

(22) Filed: Jun. 14, 2004

(30) Foreign Application Priority Data
Jun. 14, 2003 (KR) 2003-38523

(51) Int. Cl. G06F 12/00

(52) U.S. Cl. 711/112

(57) ABSTRACT

An apparatus and method to control a disc driving speed where apparatus includes processor to set a disc driving speed and to transmit information of the disc driving speed according to a predetermined protocol; a disc drive to receive and to store the information of the disc driving speed, and to drive a disc at the disc driving speed.

### CROSS-REFERENCE TO RELATED APPLICATION

This application claims the priority of Korean Patent Application No. 2003-38523, filed on Jun. 14, 2003, in the Korean Intellectual Property Office, the disclosure of which is incorporated herein in its entirety by reference.

### BACKGROUND OF THE INVENTION

1. Field of the Invention

The present invention relates to an apparatus and method to control a disc driving speed, and more particularly, to an apparatus and method to control a disc driving speed such that the disc driving speed is constant even after a corresponding disc tray opens/closes and/or a disc is changed.

2. Description of the Related Art

In line with the wide spread use of high storage capacity discs, computers generally come equipped with disc drives. A computer and a disc drive provided to the computer communicate with each other according to a communication protocol, e.g., AT Attachment Packet Interface (ATAPI) protocol.

FIG. 1 is a schematic block diagram of a computer system including a main computer 100 and a disc drive 110.

In order to communicate with the disc drive 110, the computer includes a hard disc 101, a controller 102, and a first ATAPI interface unit 103. The hard disc 101 contains a disc drive program and a related user interface. The controller 102 has a signal processor, for example, a microprocessor, to execute programs stored on the hard disc 101. The first ATAPI interface unit 103 enables communication between the main computer 100 and the disc drive 110 according to the ATAPI protocol.

The disc drive 110 includes an optical pick-up 111, a data processor 112, a servo unit 113, a micom 114, a motor drive 115, and a second ATAPI interface unit 116. The optical pick-up 111 detects signals from a disc 11, and the data processor 112 processes the signals detected by the optical pick-up 111. The servo unit 113 generates a control signal to control the positions of the optical pick-up 111 over the disc 11. The micom 114 generates a control signal to control the servo unit 113. The motor drive 115 controls the optical pick-up 111 so that the optical pick-up 111 is positioned over the disc 11 according to the control signal from the servo unit 113, and also controls a spindle motor (not shown) to drive the disc 11 at a predetermined speed. The second ATAPI interface unit 116 transmits data from the data processor 112 or information from the micom 114 to the main computer 100 according to the ATAPI protocol, and receives data or information sent from the main computer 100.

In order to control the disc driving speed, with reference to FIG. 1, a user selects a speed by which to drive the disc 11 using the disc drive program on the hard disc 101, and corresponding information of the speed is sent to the disc drive 110 through the first ATAPI interface unit 103. The second ATAPI interface unit 116 receives the speed information and forwards the same to the micom 114. The micom 114 processes the speed information and forwards a result to the servo unit 113. According to the speed information, the servo unit 113 controls the motor drive 115 to drive the spindle motor (not shown) at the corresponding speed.

According to the above described apparatus and method to control the disc driving speed, a computer program to control the speed of the disc in the disc drive is required. Thus, when using the program, the disc driving speed returns to a fundamental speed set in the disc drive whenever a disc tray of the disc drive is opened and/or closed or when a disc is changed.

### SUMMARY OF THE INVENTION

An aspect of the present invention provides an apparatus and method to control a disc driving speed, according to which the disc driving speed is not changed even when a disc tray is opened or closed, and/or a disc is changed.

According to an aspect of the present invention, an apparatus to control a disc driving speed is provided. The apparatus to control the disc driving speed comprises: a processor to establish the disc driving speed and transmit information of the disc driving speed according to a predetermined protocol; a disc drive to receive and store the information of the disc driving speed, and to drive a disc at the disc driving speed. According to an aspect of the present invention, the processor may be a personal computer (PC), a personal digital assistant (PDA), a microprocessor, a consumer device such as a digital versatile disc (DVD) player and/or any other similar programmable machine.

Additional aspects and/or advantages of the invention will be set forth in part in the description which follows and, in part, will be obvious from the description, or may be learned by practice of the invention.

According to an aspect of the present invention, the computer comprises a screen interface to allow a user to select a desired disc driving speed, and to establish the selected disc driving speed as the disc driving speed.

According to an aspect of the present invention, the screen interface includes up and/or down buttons to allow the user to increase and/or decrease the desired disc driving speed within a predetermined range.

According to an aspect of the present invention, the screen interface allows the user to directly input the desired disc driving speed.

According to an aspect of the present invention, the predetermined protocol is an AT attachment packet interface (ATAPI).

According to an aspect of the present invention, the disc drive maintains the disc driving speed until the disc driving speed is replaced with another disc drive speed.

According to another aspect of the present invention, an apparatus to control a disc driving speed is provided. The apparatus comprises: a processor having a speed setting unit to establish a disc driving speed, and a transmitting unit to transmit information of the disc driving speed according to a predetermined communication protocol; and a disc drive having a receiving unit to receive the information of the disc driving speed from the transmitting unit of the computer, a speed alternation unit to replace information of a current disc driving speed with the information of the disc driving speed, and a speed storing unit to store the information of the disc driving speed and replace the current disc driving speed in the speed alternation unit, where the disc drive drives a disc at the disc driving speed based on the information of the disc driving speed stored in the speed storing unit.

According to an aspect of the present invention, the speed setting unit of the computer comprises: a screen interface to allow a user to select a desired disc driving speed, and to establish the selected disc driving speed as the disc driving speed.

According to an aspect of the present invention, the screen interface includes up and down buttons to allow the user to increase or decrease the desired driving speed within a predetermined range.

According to an aspect of the present invention, the screen interface allows the user to directly input the desired disc driving speed.

According to an aspect of the present invention, communication protocol is an AT attachment packet interface (ATAPI) protocol.

According to one aspect of the present invention, the storing unit maintains the information of the disc driving speed until replaced with information of another disc driving speed even when a disc tray of the disc drive is opened and/or closed, or a disc in the disc tray is changed.

According to yet another aspect of the present invention, a method to control a disc driving speed of a disc drive coupled with a computer is provided. The method comprises: establishing a disc driving speed and transmitting information of the disc driving speed to the disc drive according to a predetermined communication protocol; and receiving and storing the information of the disc driving speed, and driving a disc according to the information of the disc driving speed.

According to still another aspect of the present invention, a method to control a disc driving speed of a disc drive that is combined with a computer is provided. The method comprises: establishing a disc driving speed; transmitting information of the disc driving speed according to a predetermined communication protocol; receiving and storing the information of the disc driving speed; and reproducing a disc according to the information of the disc driving speed.

According to one aspect of the present invention, the method to control the disc driving speed further comprises: providing a screen interface to allow a user to determine a desired disc driving speed, and establishing the determined disc driving speed as the disc driving speed.

According to one aspect of the present invention, the screen interface includes up and/or down buttons to allow the user to increase and/or decrease a value of the desired disc driving speed within a predetermined range.

According to one aspect of the present invention, the screen interface allows the user to directly input the desired disc driving speed.

According to one aspect of the present invention, the communication protocol is AT attachment packet interface (ATAPI) protocol.

According to one aspect of the present invention, the disc driving speed is maintained until replaced with another disc driving speed, even when a disc tray of the disc drive is opened and/or closed, or a disc is alternated.

### BRIEF DESCRIPTION OF THE DRAWINGS

The above and/or other aspects and advantages of the invention will become more apparent, and more readily appreciated from the following description of the preferred embodiments, taken in conjunction with the attached drawings of which:

FIG. 1 is a schematic block diagram of a computer and a disc drive that use an ATAPI protocol;

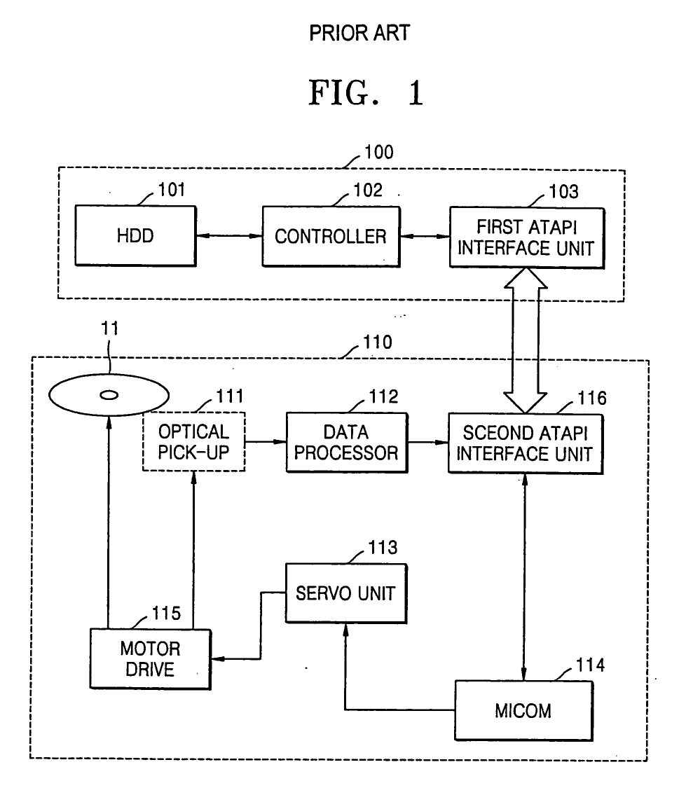

FIG. 2 is a schematic block diagram of an apparatus to control a disc driving speed according to an aspect of the present invention; and

FIG. 3 is a flowchart to illustrate a method to control a disc driving speed according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

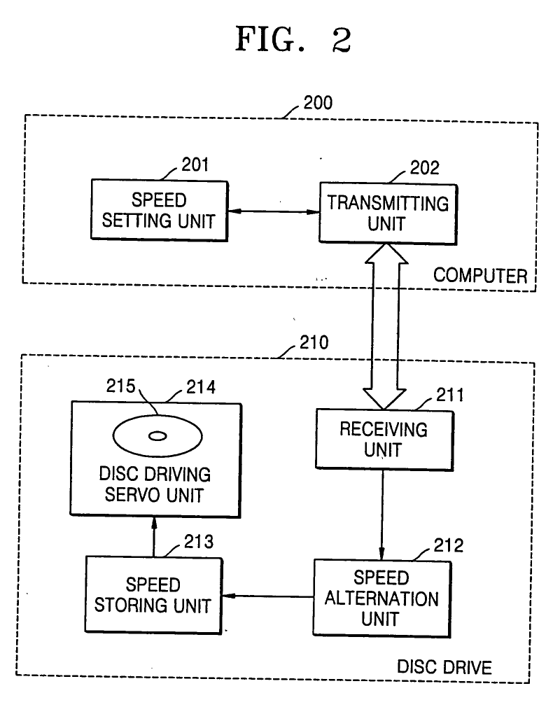

FIG. 2 is a schematic block diagram of an apparatus to control a disc driving speed according to an aspect of the present invention. The apparatus includes a computer 200 and a disc drive 210.

In order to control the disc driving speed, the computer 200 includes a speed setting unit 201 and an information transmitting unit 202, and the disc drive 210 includes a receiving unit 211, a speed alternation unit 212, and a speed storing unit 213.

The speed setting unit 201 sets a disc driving speed input by a user. According to an aspect of the present invention, the computer includes a display screen (not shown) through which the user inputs a desired disc driving speed. The display screen includes up and/or down button functions to allow the user to select a disc driving speed within a predetermined range of speeds. Accordingly, clicking the up or down buttons respectively increases or decreases the speed within the predetermined range. In addition, according to an aspect of the present invention, the user selects the desired disc driving speed from a plurality of disc driving speeds provided by a program and displayed on the display screen. Alternatively, the user directly inputs the desired disc driving speed on the display screen according to another aspect of the present invention. The disc driving speed selected/input by the user is set by the speed setting unit 201. The transmitting unit 202 transmits the disc driving speed set by the speed setting unit 201 to the disc driver 210 according to a communication protocol defined between the computer 200 and the disc drive 210.

The receiving unit 211 of the disc drive 210 receives the disc driving speed from the transmitting unit 202 of the computer 200. Further, the speed alternation unit 212 changes a current disc driving speed according to the disc driving speed received from the information receiving unit 211. The speed storing unit 213 stores the disc driving speed changed by the speed alternation unit 212. A disc driving servo unit 214 drives a disc 215 at the disc driving speed stored in the speed storing unit 213. Accordingly, because the disc driving servo unit 214 drives the disc 215 according to the disc driving speed stored in the speed storing unit 213, even after a disc tray of the disc drive 110 is opened and/or closed, or the disc 215 is changed, the disc driving speed is maintained. According to an aspect of the present invention, the disc driving speed is changed by changing the speed stored in the speed storing unit 213. Here, the new disc driving speed is input by the user, set by the speed setting unit 201, transmitted by the transmitting unit 202, received by the receiving unit 211, and changed from the old speed by the speed alternation unit 212.

The transmitting unit 202 and the receiving unit 211 correspond to a transmitting/receiving interface between the computer 200 and the disc drive 210 according to the predetermined communication protocol, e.g., the ATAPI protocol.

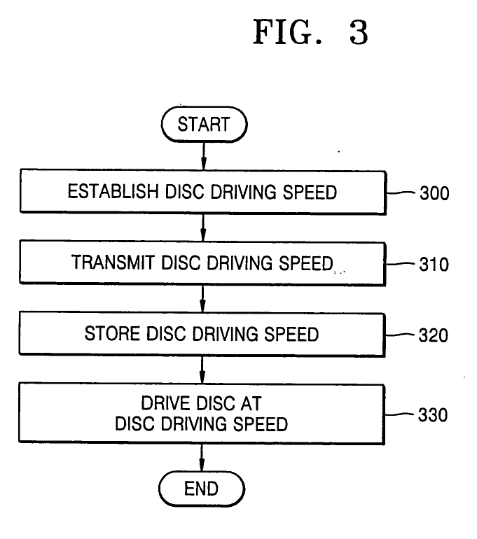

FIG. 3 illustrates a method to control a disc driving speed of a disc drive combined with a computer. Accordingly, a new disc driving speed to be set is determined by software in the computer in operation 300. To facilitate input of the new disc driving speed, the computer provides a screen interface to the user. Through the screen interface, the user selects a desired disc driving speed within a predetermined range of disc driving speeds by using up and/or down button functions, which are provided in combination with the screen interface. Alternatively, the computer provides a plurality of disc driving speeds on the screen interface to allow the user to select from the plurality of disc driving speeds. Alternatively, the user directly inputs the desired disc driving speed through an entry window on the screen interface provided by the computer. The disc driving speed selected or directly input by the user is established as the new speed to be set. The new disc driving speed is transmitted to the disc drive according to a predetermined communication protocol in operation 310. The predetermined communication protocol generally corresponds to the ATAPI protocol. The new disc driving speed replaces the old speed and is stored in a memory of the disc drive in operation 320. The disc drive drives a disc at the new disc driving speed in operation 330. The new disc driving speed is maintained until it is changed again by the above method, regardless of change in the state of a disc tray or disc alternation.

According to an aspect of the present invention, a user selects a desired disc driving speed using a computer screen interface, and the desired disc driving speed is maintained by a disc drive even when a disc tray is opened and/or closed, or a disc is changed.

Although a few embodiments of the present invention has been shown and described, it will be appreciated by those skilled in the art that various changes may be made to the embodiments without departing from the principles and spirit of the invention, the scope of which is defined in the appended claims and their equivalents.

What is claimed is:

1. An apparatus to control a disc driving speed, comprising:
a processor to establish the disc driving speed and transmit information of the disc driving speed in accordance with a predetermined protocol; and
a disc drive to receive and store the information of the disc driving speed, and to drive a disc at the disc driving speed.

2. The apparatus according to claim 1, wherein the computer comprises:
a screen interface to allow a user to select a desired disc driving speed, and to establish the desired disc driving speed as the disc driving speed.

3. The apparatus according to claim 2, wherein the screen interface comprises:
up and/or down buttons to allow the user to increase and/or decrease the desired disc driving speed within a predetermined range.

4. The apparatus according to claim 2, wherein the screen interface allows the user to directly input the desired disc driving speed.

5. The apparatus according to claim 1, wherein the predetermined protocol is an AT attachment packet interface (ATAPI).

6. The apparatus according to claim 1, wherein the disc drive maintains the disc driving speed until the disc driving speed is replaced with another disc driving speed.

7. An apparatus to control a disc driving speed, comprising:
a processor including:
a speed setting unit to establish the disc driving speed, and
a transmitting unit to transmit information of the disc driving speed in accordance with a predetermined communication protocol; and
a disc drive including:
a receiving unit to receive the information of the disc driving speed from the transmitting unit of the computer,
a speed alternation unit to replace information of a current disc driving speed with the received information of the disc driving speed, and
a speed storing unit to store the received information of the disc driving speed and to replace the current disc driving speed in the speed alternation unit, wherein the disc drive drives a disc at the disc driving speed based on the information of the disc driving speed stored in the speed storing unit.

8. The apparatus according to claim 7, wherein the speed setting unit comprises:
a screen interface to allow a user to select a desired disc driving speed, and to establish the desired disc driving speed as the disc driving speed.

9. The apparatus according to claim 8, wherein the screen interface includes up and/or down buttons to allow the user to increase and/or decrease the desired driving speed within a predetermined range.

10. The apparatus according to claim 8, wherein the screen interface allows the user to directly input the desired disc driving speed.

11. The apparatus according to claim 7, wherein the communication protocol is an AT attachment packet interface (ATAPI) protocol.

12. The apparatus according to claim 7, wherein the storing unit maintains the information of the disc driving speed until replaced with information of another disc driving speed, where the disc driving speed is maintained even when a disc tray of the disc drive is opened and/or closed or a disc is changed.

13. A method to control a disc driving speed of a disc drive coupled with a computer, comprising:
establishing the disc driving speed and transmitting information of the disc driving speed to the disc drive according to a predetermined communication protocol via the computer; and
receiving and storing the information of the disc driving speed, and driving a disc according to the information of the disc driving speed via the disc drive.

14. The method according to claim 13, further comprising:
allowing a user to determine a desired disc driving speed through a screen interface of the computer, and establishing the desired disc driving speed as the disc driving speed via the computer.

15. The method according to claim 14, wherein the screen interface includes up and/or down buttons to allow the user to increase and/or decrease the desired disc driving speed within a predetermined range.

16. The method according to claim 14, wherein the screen interface allows the user to directly input the desired disc driving speed.

17. The method according to claim 13, wherein the predetermined communication protocol is AT attachment packet interface (ATAPI) protocol.

18. The method according to claim 13, wherein the disc driving speed is maintained until replaced with another disc driving speed even when a disc tray of the disc drive is opened and/or closed or a disc is changed.

19. A method to control a disc driving speed of a disc drive combined with a computer, the method comprising:
establishing the disc driving speed via the computer;
transmitting information of the disc driving speed according to a predetermined communication protocol via the computer;
receiving and storing the information of the disc driving speed via the disc drive; and
reproducing a disc according to the information of the disc driving speed via the disc drive.

20. The method according to claim 19, further comprising:
providing a screen interface using the computer to allow a user to determine a desired disc driving speed, and
establishing the determined disc driving speed as the disc driving speed via the computer.

21. The method according to claim 20, wherein the screen interface comprises:
up and/or down buttons to allow the user to increase and/or decrease a value of the desired disc driving speed within a predetermined range.

22. The method according to claim 20, wherein the screen interface allows the user to directly input the desired disc driving speed.

23. The method according to claim 19, wherein the communication protocol is AT attachment packet interface (ATAPI) protocol.

24. The method according to claim 19, wherein the disc driving speed is maintained until replaced with another disc driving speed even when a disc tray of the disc drive is opened and/or closed or a disc is changed.

25. The method according to claim 19, wherein the disc driving speed is established when the user selects from preset disc driving speeds of the computer.

26. The method according to claim 19, wherein the disc driving speed is maintained until the information of the disc driving speed stored in the speed storing unit is changed.

27. An apparatus to control a disc driving speed of a disc drive coupled to a computer, comprising:
a processor to set the disc driving speed of the disc drive in accordance with information received from the computer according to a communication protocol; and
an interface unit to transmit and to receive disc driving speed data; and
a storing unit to store the disc driving speed data, wherein the disc driving speed is maintained based on the stored disc driving speed data.

28. The apparatus according to claim 27, wherein the communication protocol is an AT attachment packet interface (ATAPI).

29. The apparatus according to claim 27, further comprising:
an input unit to allow a user to set a desired disc driving speed.

30. A method to control a disc driving speed of a disc drive coupled to a computer, comprising:
setting the disc driving speed of the disc drive in accordance with information received from the computer according to a communication protocol; and
storing and maintaining the set disc driving speed of the disc drive.

31. The method according to claim 32, wherein the communication protocol is an AT attachment packet interface (ATAPI).

32. The method according to claim 32, further comprising:
displaying a screen to allow a user to select a desired disc driving speed, wherein the selected disc driving speed is set as the disc driving speed and replaces the stored disc driving speed.

33. The method according to claim 34, wherein the screen provides the user with an option to increase and/or decrease a value of the desired disc driving speed within a predetermined range.

34. The method according to claim 32, wherein the disc driving speed is maintained when a disc tray of the disc drive is opened and/or closed or a disc is changed.

35. A method to control a disc driving speed of a disc drive coupled to a computer, comprising:
setting the disc driving speed of the disc drive in accordance with information received from the computer according to a communication protocol; and
maintaining the set disc driving speed of the disc drive, wherein the disc driving speed is maintained when a disc tray is opened and/or closed.
